(19) United States
(12) Patent Application Publication
(10) Pub. No.: US 2026/0253805 A1
(43) Pub. Date: Aug. 27, 2026

(54) MULTILAYER CERAMIC CAPACITOR

(71) Applicant: Murata Manufacturing Co., Ltd., Nagaokakyo-shi (JP)

(72) Inventors: Yoshihiro FUKUDA, Nagaokakyo-shi (JP); Takashi SAWADA, Nagaokakyo-shi (JP)

(21) Appl. No.: 19/446,047

(22) Filed: Jan. 12, 2026

(30) Foreign Application Priority Data
Feb. 25, 2025 (JP) 2025-027506

(51) Int. Cl. H01G 4/30; H01G 4/232

(52) U.S. Cl. CPC H01G 4/30; H01G 4/2325

(57) ABSTRACT

A multilayer ceramic capacitor includes a multilayer body with a dimension in a first direction that is shorter than a dimension of the multilayer body in a second direction, and a dimension of the multilayer body in a stacking direction that is shorter than the dimension of the multilayer body in the first direction. A first outer electrode includes a first cover portion and first to fourth folded portions, and a second outer electrode includes a second cover portion and fifth to eighth folded portions. The first folded portion includes a first maximum thickness point in a stacking direction. The fifth folded portion includes a second maximum thickness point in the stacking direction. The first and second maximum thickness points are diagonally opposite to each other with respect to a center point of the first surface.

### CROSS REFERENCE TO RELATED APPLICATIONS

This application claims the benefit of priority to Japanese Patent Application No. 2025-027506 filed on Feb. 25, 2025. The entire contents of this application are hereby incorporated herein by reference.

### BACKGROUND OF THE INVENTION

### 1. Field of the Invention

The present invention relates to multilayer ceramic capacitors.

### 2. Description of the Related Art

Conventionally known multilayer ceramic electronic components include multilayer ceramic capacitors. A typical multilayer ceramic capacitor includes a multilayer body having a substantially cuboid shape in which the dimension in the length direction is greater than that in the width direction. At both end portions of the multilayer body in the length direction, outer electrodes are provided. On the other hand, an LW reversed multilayer ceramic capacitor is also known, in which the equivalent series inductance (ESL) is reduced by reversing the magnitude relationship between the dimension of the multilayer body in the length direction and the dimension in the width direction (see, for example, Japanese Unexamined Patent Application Publication Nos. 2020-57753 and 2020-61524).

In recent years, as the substrate mounting density has increased, the mounting area available for multilayer ceramic capacitors has decreased. Therefore, the package on package (POP) mounting configuration has been used, thus increasing the demand for multilayer ceramic capacitors mounted as land side capacitors (LSCs) on the lower end portion of the substrate. For such multilayer ceramic capacitors mounted as LSCs, low-profile multilayer ceramic capacitors with a small thickness in the height direction are required.

In a manufacturing process (including a measurement process, a visual inspection process, and a packaging process) of a multilayer ceramic capacitor, when the contact area of the chip with the conveying section is large during chip conveyance by equipment, the chip may adhere to the conveying section due to static electricity or the like. Such chip conveyance failures result in a decrease in productivity (the equipment utilization rate). Particularly in the multilayer ceramic capacitor having a small thickness in the height direction, the chip is lightweight, and the problem becomes more pronounced.

### SUMMARY OF THE INVENTION

Example embodiments of the present invention each provide a structure that reduces a contact area of a chip with a conveying section during chip conveyance by equipment in a manufacturing process, thus reducing or preventing chip adhesion due to static electricity or the like and reducing or preventing chip conveyance failures so as to improve productivity.

A multilayer ceramic capacitor according to an example embodiment of the present invention includes a multilayer body including a plurality of stacked dielectric layers, a plurality of inner electrode layers stacked on respective dielectric layers of the plurality of dielectric layers, a first surface and a second surface facing each other in a stacking direction, a third surface and a fourth surface facing each other in a first direction perpendicular or substantially perpendicular to the stacking direction, and a fifth surface and a sixth surface facing each other in a second direction perpendicular or substantially perpendicular to the stacking direction and the first direction, a first inner electrode layer extending to the third surface, a second inner electrode layer extending to the fourth surface, a first outer electrode on the third surface and connected to the first inner electrode layer, and a second outer electrode on the fourth surface and connected to the second inner electrode layer, in which a dimension of the multilayer body in the first direction is shorter than a dimension of the multilayer body in the second direction, a dimension of the multilayer body in the stacking direction is shorter than the dimension of the multilayer body in the first direction, the first outer electrode includes a first cover portion on the third surface, a first folded portion on a portion of the first surface, a second folded portion on a portion of the second surface, a third folded portion on a portion of the fifth surface, and a fourth folded portion on a portion of the sixth surface, the second outer electrode includes a second cover portion on the fourth surface, a fifth folded portion a portion of the first surface, a sixth folded portion on a portion of the second surface, a seventh folded portion on a portion of the fifth surface, and an eighth folded portion on a portion of the sixth surface, the first folded portion includes a first maximum thickness point that is a region with a greatest thickness in the stacking direction, the fifth folded portion includes a second maximum thickness point that is a region with a greatest thickness in the stacking direction, and the first maximum thickness point of the first folded portion and the second maximum thickness point of the fifth folded portion are located diagonally opposite to each other with respect to a center point of the first surface in the first direction and the second direction.

In the multilayer ceramic capacitor according to the above-described example embodiment of the present invention, the dimension of the multilayer body in the first direction is shorter than the dimension of the multilayer body in the second direction, and the dimension of the multilayer body in the stacking direction is shorter than the dimension of the multilayer body in the first direction. Furthermore, the first folded portion includes the first maximum thickness point that is a region with the greatest thickness in the stacking direction, and the fifth folded portion includes the second maximum thickness point that is a region with the greatest thickness in the stacking direction. The first maximum thickness point of the first folded portion and the second maximum thickness point of the fifth folded portion are located diagonally opposite to each other with respect to the center point of the first surface in the first direction and the second direction. As a result, during conveyance of the multilayer ceramic capacitor by equipment in a manufacturing process (a measurement process, a visual inspection process, and a packaging process) of a multilayer ceramic capacitor, a contact area of a chip with a conveying section is reduced. This reduces or prevents chip adhesion due to static electricity or the like and reduces or prevents conveyance failures of the multilayer ceramic capacitor to improve productivity (the equipment utilization rate).

According to example embodiments of the present invention, it is possible to provide structures that each reduce a contact area of a chip with a conveying section during chip conveyance by equipment in a manufacturing process, thus reducing or preventing chip adhesion due to static electricity or the like and reducing or preventing chip conveyance failures to improve productivity.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an exterior perspective view of an example of a multilayer ceramic capacitor according to an example embodiment of the present invention.

FIG. 2 is a plan view of an example of a multilayer ceramic capacitor according to an example embodiment of the present invention.

FIG. 3 is a side view of an example of a multilayer ceramic capacitor according to an example embodiment of the present invention.

FIG. 4 is a sectional view taken along line IV-IV in FIG. 1.

FIG. 5 is a sectional view taken along line V-V in FIG. 1.

FIG. 6 is a sectional view taken along line VI-VI in FIG. 1.

FIG. 7 is an explanatory diagram of an example of a manufacturing method according to an example embodiment of the present invention illustrating a process to form an underlying electrode layer.

FIG. 8 is an explanatory diagram of an example of a manufacturing method according to an example embodiment of the present invention illustrating a process to form a maximum thickness portion.

FIG. 9 is an explanatory diagram for explaining an offset amount of a maximum thickness point in a folded portion from a center line in a second direction in an experimental example.

### DETAILED DESCRIPTION OF THE EXAMPLE EMBODIMENTS

Example embodiments of the present invention will be described in detail with reference to the drawings.

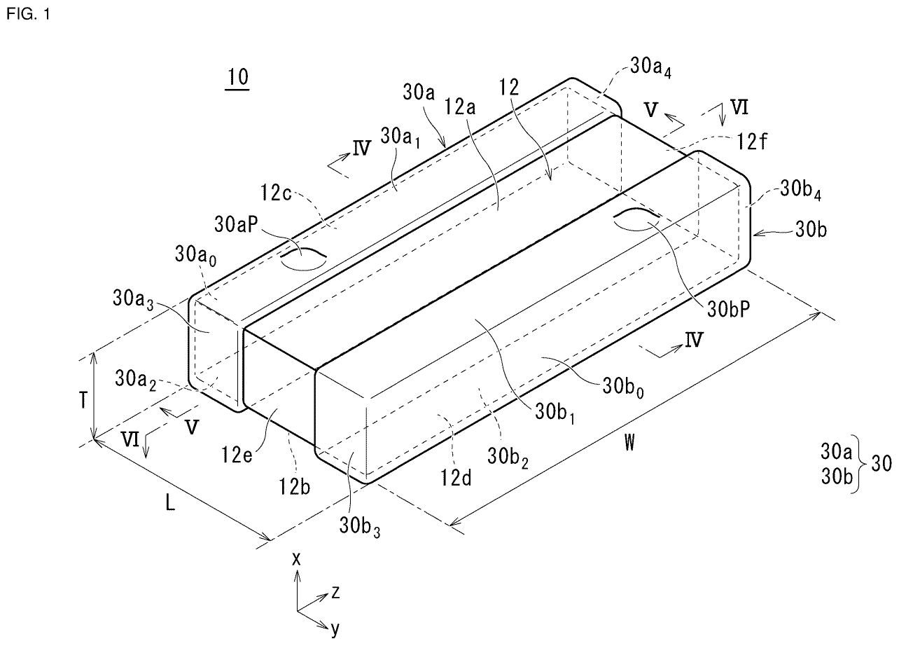

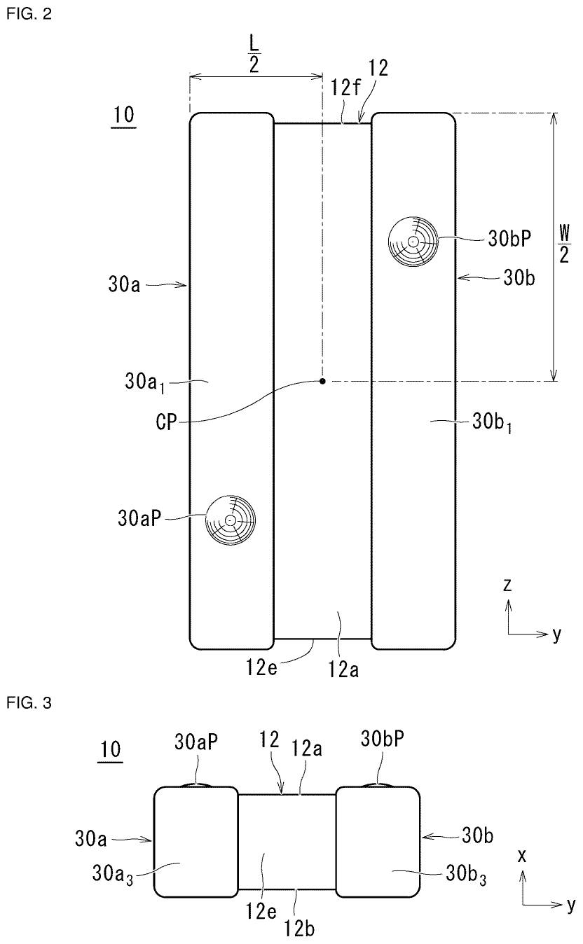

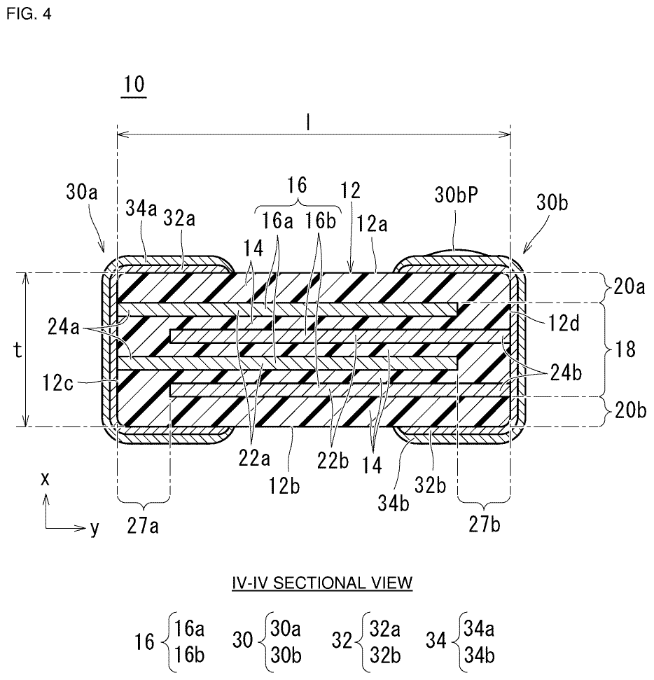

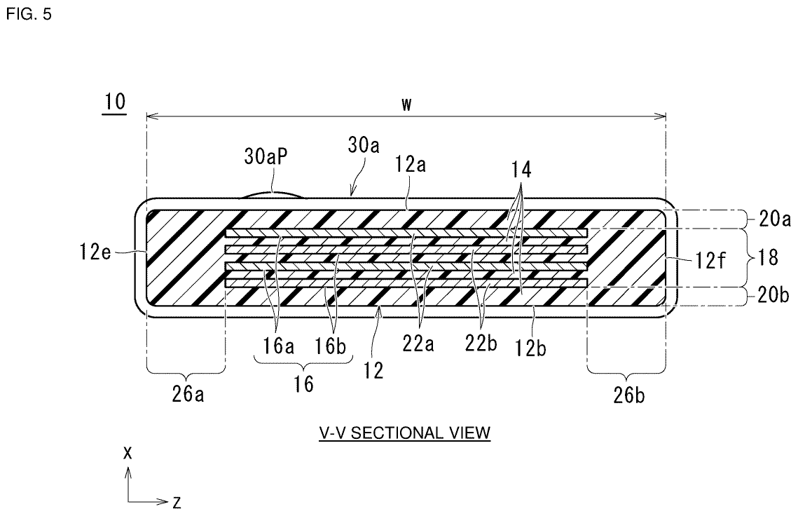

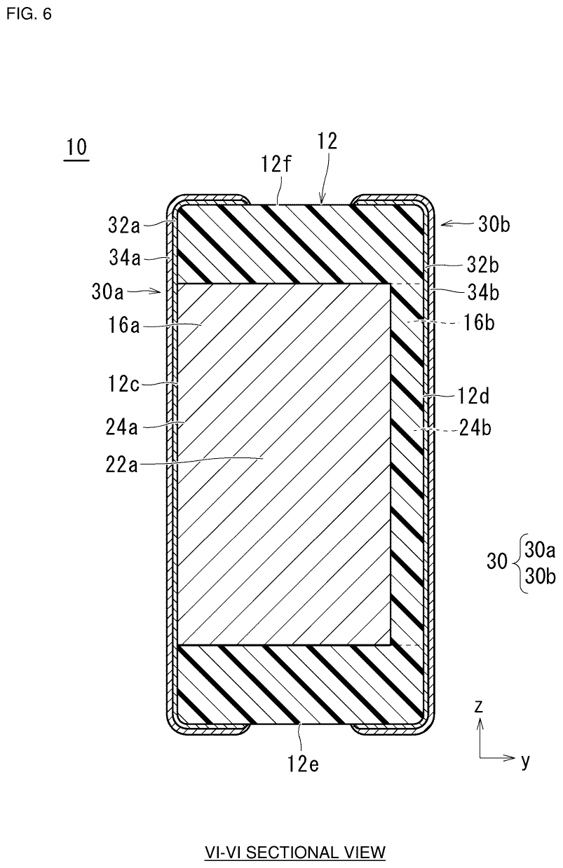

FIG. 1 is an exterior perspective view of an example of a multilayer ceramic capacitor according to an example embodiment of the present invention. FIG. 2 is a plan view of the example of the multilayer ceramic capacitor according to the present example embodiment of the present invention. FIG. 3 is a side view of the example of the multilayer ceramic capacitor according to the present example embodiment of the present invention. FIG. 4 is a sectional view taken along line IV-IV in FIG. 1. FIG. 5 is a sectional view taken along line V-V in FIG. 1. FIG. 6 is a sectional view taken along line VI-VI in FIG. 1.

As illustrated in FIGS. 1 to 3, a multilayer ceramic capacitor 10 includes a cuboid-shaped multilayer body 12 and outer electrodes 30 disposed at both end portions of the multilayer body 12.

The multilayer body 12 includes a plurality of stacked dielectric layers 14 and a plurality of inner electrode layers 16 stacked on the respective dielectric layers 14. The inner electrode layers 16 include first inner electrode layers 16a and second inner electrode layers 16b. The first and second inner electrode layers 16a and 16b will be described later in detail.

The multilayer body 12 includes a first surface 12a and a second surface 12b, which face each other in a stacking direction x, a third surface 12c and a fourth surface 12d, which face each other in a first direction y perpendicular or substantially perpendicular to the stacking direction x, and a fifth surface 12e and a sixth surface 12f, which face each other in a second direction z perpendicular or substantially perpendicular to the stacking direction x and the first direction y.

The multilayer body 12 has a cuboid shape. Preferably, corner portions and edge portions of the multilayer body 12 are rounded. Each corner portion corresponds to an intersection of three faces of the multilayer body 12. Each edge portion corresponds to an intersection of two faces of the multilayer body 12. The first and second surfaces 12a and 12b, the third and fourth surfaces 12c and 12d, and the fifth and sixth surfaces 12e and 12f may include irregularities on all or a portion thereof.

The dimension of the multilayer body 12 in the first direction y is defined as an l dimension, the dimension of the multilayer body 12 in the second direction z is defined as a w dimension, and the dimension of the multilayer body 12 in the stacking direction x is defined as a t dimension. These dimensions satisfy a relationship of w>1>t.

The multilayer body 12 includes a capacitance generating section 18, and a first outer layer section 20a located on the first surface 12a side and a second outer layer section 20b located on the second surface 12b side, with the capacitance generating section 18 interposed therebetween in the stacking direction x.

In the capacitance generating section 18, the first inner electrode layers 16a and the second inner electrode layers 16b are alternately stacked with the dielectric layers 14 interposed therebetween.

The first outer layer section 20a is located in the first surface 12a side of the multilayer body 12 and is an aggregate of a plurality of dielectric layers 14 located between the first surface 12a and the portion of the capacitance generating section 18 closest to the first surface 12a. The second outer layer section 20b is located in the second surface 12b side of the multilayer body 12 and is an aggregate of a plurality of dielectric layers 14 located between the second surface 12b and the portion of the capacitance generating section 18 closest to the second surface 12b. Furthermore, the region interposed between the first outer layer section 20a and the second outer layer section 20b is the capacitance generating section 18.

The capacitance generating section 18 is disposed at the center in the stacking direction x. More specifically, in the stacking direction x connecting the first surface 12a and the second surface 12b, the center position of the multilayer body 12 is the same or substantially the same as the center position of the capacitance generating section 18.

As illustrated in FIG. 5, the multilayer body 12 includes side portions (W gaps) 26a and 26b of the multilayer body 12, which are located between the capacitance generating section 18 and the fifth surface 12e and between the capacitance generating section 18 and the sixth surface 12f, respectively.

As illustrated in FIG. 4, the multilayer body 12 includes end portions (L gaps) 27a and 27b of the multilayer body 12, which are respectively located between the capacitance generating section 18 and the third surface 12c and between the capacitance generating section 18 and the fourth surface 12d and respectively include first extended electrode portions 24a of the first inner electrode layers 16a and second extended electrode portions 24b.

The dielectric layers 14 can be made of dielectric ceramic including, for example, BaTiO₃, CaTiO₃, SrTiO₃, CaZrO₃, or another component as the ceramic material. In addition to those main components, the dielectric layers 14 may include, for example, a secondary component, such as a Mn compound, an Fe compound, a Cr compound, a Co compound, or a Ni compound.

The thickness of each dielectric layer 14 is preferably, for example, about 0.30 μm or more and about 5.00 μm or less. The number of stacked dielectric layers 14 is preferably, for example, 10 or more and 200 or less. This number of dielectric layers 14 is the total number of the dielectric layers 14 within the capacitance generating section 18 and the dielectric layers 14 within the first and second outer layer sections 20a and 20b.

As illustrated in FIGS. 4 and 5, the inner electrode layers 16 include the first inner electrode layers 16a and the second inner electrode layers 16b. The first and second inner electrode layers 16a and 16b are alternately stacked with inner dielectric layers 14 interposed therebetween.

The first inner electrode layers 16a are disposed on the respective dielectric layers 14 and are located within the multilayer body 12. Each of the first inner electrode layers 16a includes a first opposing electrode portion 22a, which faces the adjacent second inner electrode layers 16b, and a first extended electrode portion 24a, which is located at one end of the first inner electrode layer 16a and extends from the first opposing electrode portion 22a to the third surface 12c of the multilayer body 12. The end portion of the first extended electrode portion 24a is extended to the surface of the third surface 12c and is exposed from the multilayer body 12. That is, the end portion of the first extended electrode portion 24a is not exposed to the first, second, fourth, fifth, and sixth surfaces 12a, 12b, 12d, 12e, and 12f. Specifically, the end portion of each first inner electrode layer 16a is slightly retracted from the fourth surface 12d.

The shape of the first opposing electrode portion 22a of each first inner electrode layer 16a is not limited but is preferably, for example, rectangular or substantially rectangular in plan view. The corner portions in plan view may be rounded, or obliquely provided (tapered) in plan view. Alternatively, the first opposing electrode portion 22a may have a tapered shape in plan view that is inclined in either direction.

The shape of the first extended electrode portion 24a of each first inner electrode layer 16a is not limited but is preferably, for example, rectangular or substantially rectangular in plan view. The corner portions in plan view may be rounded, or obliquely provided (tapered) in plan view. Alternatively, the first extended electrode portion 24a may have a tapered shape in plan view that is inclined in either direction.

The second inner electrode layers 16b are disposed on the respective dielectric layers 14 and are located within the multilayer body 12. Each of the second inner electrode layers 16b includes a second opposing electrode portion 22b, which faces the adjacent first inner electrode layers 16a, and a second extended electrode portion 24b, which is located at one end of the second inner electrode layer 16b and extends from the second opposing electrode portion 22b to the fourth surface 12d of the multilayer body 12. The end portion of the second extended electrode portion 24b is extended to the surface of the fourth surface 12d and is exposed from the multilayer body 12. That is, the end portion of the second extended electrode portion 24b is not exposed to the first, second, third, fifth, and sixth surfaces 12a, 12b, 12c, 12e, and 12f. Specifically, the end portion of each second inner electrode layer 16b is slightly retracted from the third surface 12c.

The shape of the second opposing electrode portion 22b of each second inner electrode layer 16b is not limited but is preferably, for example, rectangular or substantially rectangular in plan view. The corner portions in plan view may be rounded, or obliquely provided (tapered) in plan view. Alternatively, the second opposing electrode portion 22b may have a tapered shape in plan view that is inclined in either direction.

The shape of the second extended electrode portion 24b of each second inner electrode layer 16b is not limited but is preferably, for example, rectangular or substantially rectangular in plan view. The corner portions in plan view may be rounded, or obliquely provided (tapered) in plan view. Alternatively, the second extended electrode portion 24b may have a tapered shape in plan view that is inclined in either direction.

The width of the second opposing electrode portion 22b in each second inner electrode layer 16b may be equal or substantially equal to that of the second extended electrode portion 24b in each second inner electrode layer 16b, or the width of either portion may be smaller than the other.

The number of the first inner electrode layers 16a is not limited, but is preferably, for example, one or more and 100 or less. The number of the second inner electrode layers 16b is not limited, but is preferably, for example, one or more and 100 or less. Therefore, the total number of the first and second inner electrode layers 16a and 16b is preferably, for example, two or more and 200 or less.

The thickness of each first inner electrode layer 16a is not limited, but is preferably, for example, about 0.30 μm or more and about 3.00 μm or less. The thickness of each second inner electrode layer 16b is not limited, but is preferably, for example, about 0.30 μm or more and about 3.00 μm or less.

The first and second inner electrode layers 16a and 16b can be made of a conductive material, including, for example, metal, such as Ni, Cu, Ag, Pd, or Au, or an alloy including at least one of these metals, such as Ag—Pd alloy. When, for example, Cu is the main component, its high conductivity can provide low loss characteristics (that is, high Q characteristics).

When, for example, Sn layers are included between the first and second inner electrode layers 16a and 16b and the dielectric layers 14, the Sn layers can reduce electric field concentration at interfaces between the inner electrode layers and the ceramic layers, thus improving the reliability during high-temperature loading.

On the third surface 12c side of the multilayer body 12 and the fourth surface 12d side thereof, the outer electrodes 30 are disposed as illustrated in FIGS. 1 to 3.

Each outer electrode 30 includes, for example, an underlying electrode layer 32, which includes a metal component and glass, and a plating layer 34, which is disposed on the surface of the underlying electrode layer 32.

The outer electrodes 30 include a first outer electrode 30a and a second outer electrode 30b.

The first outer electrode 30a is disposed on the third surface 12c side. The first outer electrode 30a is connected to the first inner electrode layers 16a. The first outer electrode 30a includes a first cover portion 30a₀, which is disposed on the third surface 12c and covers the first inner electrode layers 16a exposed in the third surface 12c, a first folded portion 30a₁, which extends from the first cover portion 30a₀ and is located on a portion of the first surface 12a, a second folded portion 30a₂, which extends from the first cover portion 30a₀ and is located on a portion of the second surface 12b, a third folded portion 30a₃, which extends from the first cover portion 30a₀ and is located on a portion of the fifth surface 12e, and a fourth folded portion 30a₄, which extends from the first cover portion 30a₀ and is located on a portion of the sixth surface 12f.

The second outer electrode 30b is disposed on the fourth surface 12d side. The second outer electrode 30b is connected to the second inner electrode layers 16b. The second outer electrode 30b includes a second cover portion 30b₀, which is disposed on the fourth surface 12d and covers the second inner electrode layers 16b exposed in the fourth surface 12d, a fifth folded portion 30b₁, which extends from the second cover portion 30b₀ and is located on a portion of the first surface 12a, a sixth folded portion 30b₂, which extends from the second cover portion 30b₀ and is located on a portion of the second surface 12b, a seventh folded portion 30b₃, which extends from the second cover portion 30b₀ and is located on a portion of the fifth surface 12e, and an eighth folded portion 30b₄, which extends from the second cover portion 30b₀ and is located on a portion of the sixth surface 12f.

The first outer electrode 30a includes a first maximum thickness point 30aP, which is a region with the greatest thickness in the stacking direction x in the first folded portion 30a₁, which is located on the first surface 12a. The first maximum thickness point 30aP of the first folded portion 30a₁, which is located on the first surface 12a, is located in the fifth surface 12e side of the first folded portion 30a₁.

The second outer electrode 30b includes a second maximum thickness point 30bP, which is a region with the greatest thickness in the stacking direction x in the fifth folded portion 30b₁, which is located on the first surface 12a. The second maximum thickness point 30bP of the fifth folded portion 30b₁, which is located on the first surface 12a, is located in the sixth surface 12f side of the fifth folded portion 30b₁.

The first outer electrode 30a includes a minimum thickness point in a region of the first folded portion 30a₁ that is specified in a range excluding regions within, for example, about 10% of the dimension of the first folded portion 30a₁ in the second direction z from both ends of the first folded portion 30a₁ in the second direction z.

The second outer electrode 30b includes a minimum thickness point in a region of the fifth folded portion 30b₁ that is specified in a range excluding regions within, for example, about 10% of the dimension of the fifth folded portion 30b₁ in the second direction z from both ends of the fifth folded portion 30b₁ in the second direction z.

The first maximum thickness point 30aP of the first folded portion 30a₁ and the second maximum thickness point 30bP of the fifth folded portion 30b₁ are located diagonally opposite to each other with respect to a center point CP of the first surface 12a in the first and second directions y and z as illustrated in FIG. 2.

Preferably, the first maximum thickness point 30aP of the first folded portion 30a₁ is located on the fifth surface 12e side of the center of the first folded portion 30a₁ in the second direction z. Preferably, the second maximum thickness point 30bP of the fifth folded portion 30b₁ is located on the sixth surface 12f side of the center of the fifth folded portion 30b₁ in the second direction z.

Preferably, the first maximum thickness point 30aP of the first folded portion 30a₁ is located at a position excluding a range of, for example, about ±10% of the length of the first folded portion 30a₁ in the second direction z from the center of the first folded portion 30a₁ in the second direction z. Preferably, the second maximum thickness point 30bP of the fifth folded portion 30b₁ is located at a position excluding a range of, for example, about ±10% of the length of the fifth folded portion 30b₁ in the second direction z from the center of the fifth folded portion 30b₁ in the second direction z.

The ratio of the thickness at the first maximum thickness point 30aP of the first folded portion 30a₁ to the thickness at the minimum thickness point of the first folded portion 30a₁ is preferably, for example, about 1.4 or more and about 2.5 or less. The ratio of the thickness at the second maximum thickness point 30bP of the fifth folded portion 30b₁ to the thickness at the minimum thickness point of the fifth folded portion 30b₁ is preferably, for example, about 1.4 or more and about 2.5 or less.

According to the above-described configuration, during chip conveyance by equipment in the manufacturing process of a multilayer ceramic capacitor, particularly in a measurement process, a visual inspection process, and a packaging process, the contact area of the chip with a conveying section is reduced. As a result, chip adhesion due to static electricity or the like is reduced or prevented, thus reducing or preventing chip conveyance failures to improve productivity (the equipment utilization rate).

Here, for example, the thickness values at the first maximum thickness point 30aP of the first folded portion 30a₁ and the second maximum thickness point 30bP of the fifth folded portion 30b₁ are measured as follows.

The positions of the first maximum thickness point 30aP of the first outer electrode 30a and the second maximum thickness point 30bP of the second outer electrode 30b are identified using a laser displacement meter.

For measuring the thickness at the first maximum thickness point 30aP of the first outer electrode 30a, the height position of the first maximum thickness point 30aP and the height position of the surface of the multilayer body 12 are read from the laser displacement graph on an LT plane including the first maximum thickness point 30aP. Then the difference between the read height positions of the first maximum thickness point 30aP of the first outer electrode 30a and the surface of the multilayer body 12 is defined as the thickness value at the first maximum thickness point 30aP of the first outer electrode 30a.

For measuring the thickness at the second maximum thickness point 30bP of the second outer electrode 30b, the height position of the second maximum thickness point 30bP and the height position of the surface of the multilayer body 12 are read from the laser displacement graph at an LT plane including the second maximum thickness point 30bP. Then the difference between the read height positions of the second maximum thickness point 30bP of the second outer electrode 30b and the surface of the multilayer body 12 is defined as the thickness value at the second maximum thickness point 30bP of the second outer electrode 30b.

Here, for example, the thickness value at the minimum thickness point of the first folded portion 30a₁ and the thickness value at the minimum thickness point of the fifth folded portion 30b₁ are measured as follows.

By using a laser displacement meter, the position of the minimum thickness point in the first outer electrode 30a is identified in a range excluding regions within about 10% of the dimension of the first folded portion 30a₁ in the second direction z from both ends of the first folded portion 30a₁ in the second direction z. In a similar manner, the position of the minimum thickness point in the second outer electrode 30b is identified in a range excluding regions within about 10% of the dimension of the fifth folded portion 30b₁ in the second direction z from both ends of the fifth folded portion 30b₁ in the second direction z.

For the thickness at the minimum thickness point of the first outer electrode 30a, the height position of the minimum thickness point of the first outer electrode 30a, whose position was identified in the range excluding regions within about 10% of the dimension of the first folded portion 30a₁ in the second direction z from both ends of the first folded portion 30a₁ in the second direction z, and the height position of the surface of the multilayer body 12 are read from the laser displacement graph at a position about half the length of the first folded portion 30a₁ on a WT plane. The difference between the read height positions of the minimum thickness point of the first outer electrode 30a and the surface of the multilayer body 12 is defined as the thickness value at the minimum thickness point of the first outer electrode 30a.

For the thickness at the minimum thickness point of the second outer electrode 30b, the height position of the minimum thickness point of the second outer electrode 30b, whose position was identified in the range excluding regions within about 10% of the dimension of the fifth folded portion 30b₁ in the second direction z from both ends of the fifth folded portion 30b₁ in the second direction z, and the height position of the surface of the multilayer body 12 are read from the laser displacement graph at a position half the length of the fifth folded portion 30b₁ on a WT plane. The difference between the read height positions of the minimum thickness point of the second outer electrode 30b and the surface of the multilayer body 12 is defined as the thickness value at the minimum thickness point of the second outer electrode 30b.

The first maximum thickness point 30aP, which is disposed in the first folded portion 30a₁, and the second maximum thickness point 30bP, which is disposed in the fifth folded portion 30b₁, are located diagonally opposite to each other with respect to the center point CP of the first surface 12a of the multilayer ceramic capacitor 10 in the first and second directions y and z. This can reduce the contact area of the chip with the conveying section of the equipment.

If the thicknesses of the first folded portion 30a₁ and the fifth folded portion 30b₁ greatly differ within the respective folded planes, the contact area of the chip with the conveying section of the equipment is further reduced, thus further reducing or preventing chip conveyance failures.

Within the multilayer body 12, the first opposing electrode portions 22a of the first inner electrode layers 16a and the second opposing electrode portions 22b of the second inner electrode layers 16b face each other with the dielectric layers 14 interposed therebetween, thus generating an electrostatic capacitance. As a result, the electrostatic capacitance is obtained between the first outer electrode 30a connected to the first inner electrode layers 16a and the second outer electrode 30b connected to the second inner electrode layers 16b, thus providing capacitor characteristics.

The outer electrodes 30 include the underlying electrode layers 32, which are disposed on the surface of the multilayer body 12, and the plating layers 34, which are disposed to cover the respective underlying electrode layers 32.

The underlying electrode layers 32 include a first underlying electrode layer 32a and a second underlying electrode layer 32b.

The plating layers 34 include a first plating layer 34a and a second plating layer 34b.

In other words, the first outer electrode 30a includes the first underlying electrode layer 32a and the first plating layer 34a. The second outer electrode 30b includes the second underlying electrode layer 32b and the second plating layer 34b.

The first underlying electrode layer 32a is disposed on the surface of the third surface 12c of the multilayer body 12 and extends from the third surface 12c so as to partially cover the first, second, fifth, and sixth surfaces 12a, 12b, 12e, and 12f.

The second underlying electrode layer 32b is disposed on the surface of the fourth surface 12d of the multilayer body 12 and extends from the fourth surface 12d so as to partially cover the first, second, fifth, and sixth surfaces 12a, 12b, 12e, and 12f.

The underlying electrode layer 32 includes at least one of, for example, a fired layer, a conductive resin layer, and the like.

Hereinafter, the configurations in which each underlying electrode layer 32 includes the fired layer or conductive resin layer will be described.

The fired layer includes a glass component and a metal component. The glass component of the fired layer includes at least one of, for example, B, Si, Ba, Mg, Al, Li, or the like. The metal component of the fired layer includes at least one of, for example, Cu, Ni, Ag, Pd, Ag—Pd alloy, Au, or the like. The fired layer may include multiple layers. The fired layer is formed by applying the conductive paste containing the glass and metal components to the multilayer body 12 and firing it. The fired layer may be formed by simultaneously firing a multilayer chip including the inner electrode layers 16 and the dielectric layers 14 and the conductive paste applied to the multilayer chip or may be formed by firing a multilayer chip including the inner electrode layers 16 and the dielectric layers 14 into the multilayer body 12 and then applying a conductive paste to the multilayer body 12, followed by firing. In the case of forming the fired layer by simultaneously firing a multilayer chip including the inner electrode layers 16 and the dielectric layers 14 and the conductive paste applied to the multilayer chip, the fired layer is preferably formed by firing a conductive paste including a dielectric material instead of the glass component.

Preferably, the portion of the first underlying electrode layer 32a located on the third surface 12c, at the center in the stacking direction x, has a thickness in the first direction y connecting the third surface 12c and the fourth surface 12d of, for example, about 10 μm or more and about 40 μm or less.

Preferably, the portion of the second underlying electrode layer 32b located on the fourth surface 12d, at the center in the stacking direction x, has a thickness in the first direction y connecting the third surface 12c and the fourth surface 12d of, for example, about 10 μm or more and about 40 μm or less.

When the first underlying electrode layer 32a is provided on a portion of the first surface 12a, a portion of the second surface 12b, a portion of the fifth surface 12e, and a portion of the sixth surface 12f, the portions of the first underlying electrode layer 32a located on the first and second surfaces 12a and 12b, at respective centers in the first direction y connecting the third surface 12c and the fourth surface 12d, preferably have thicknesses in the stacking direction x connecting the first surface 12a and the second surface 12b of, for example, about 3 μm or more and about 30 μm or less. Furthermore, the portions of the first underlying electrode layer 32a located on the fifth and sixth surfaces 12e and 12f, at respective centers in the first direction y connecting the third surface 12c and the fourth surface 12d, preferably have thicknesses in the second direction z connecting the fifth surface 12e and the sixth surface 12f of, for example, about 3 μm or more and about 30 μm or less.

When the second underlying electrode layer 32b is provided on a portion of the first surface 12a, a portion of the second surface 12b, a portion of the fifth surface 12e, and a portion of the sixth surface 12f, the portions of the second underlying electrode layer 32b located on the first and second surfaces 12a and 12b, at respective centers in the first direction y connecting the third surface 12c and the fourth surface 12d, preferably have thicknesses in the stacking direction x connecting the first surface 12a and the second surface 12b of, for example, about 3 μm or more and about 30 μm or less. Furthermore, the portions of the second underlying electrode layer 32b located on the fifth and sixth surfaces 12e and 12f, at respective centers in the first direction y connecting the third surface 12c and the fourth surface 12d, preferably have thicknesses in the second direction z connecting the fifth surface 12e and the sixth surface 12f of, for example, about 3 μm or more and about 30 μm or less.

The conductive resin layer may be disposed on the fired layer so as to cover the fired layer or may be disposed directly on the multilayer body 12 without the fired layer. The conductive resin layer may completely or partially cover the fired layer. Furthermore, the conductive resin layer may include multiple layers.

The conductive resin layer includes, for example, a thermosetting resin and metal. Since the conductive resin layer includes thermosetting resin, the conductive resin layer is more flexible than, for example, a plating layer and a fired layer made of a fired conductive paste. Therefore, the conductive resin layer defines and functions as a buffer layer to reduce or prevent cracking of the multilayer ceramic capacitor 10, even when the multilayer ceramic capacitor 10 is subjected to a physical shock or a stress resulting from thermal cycling.

The metal included in the conductive resin layer can be, for example, Ag, Cu, Ni, Sn, Bi, or an alloy including these metals. Alternatively, the metal can be, for example, metal powder in which the surfaces of the metal powders are coated with Ag. In the case of using metal powder in which the surfaces of the metal powders are coated with Ag, it is preferable that the metal powders are, for example, Cu, Ni, Sn, Bi, or an alloy thereof. The reason for using Ag conductive metal powder as the conductive metal is that Ag has the lowest resistivity among metals and is suitable as the electrode material. Furthermore, because Ag is a noble metal, Ag does not oxidize and has a high weather resistance. In addition, the base material of the metal powder may be an inexpensive metal, while the above-described characteristics of Ag are maintained.

The metal included in the conductive resin layer can be, for example, Cu or Ni subjected to antioxidation treatment. The metal included in the conductive resin layer can be, for example, metal powder in which the surfaces of the metal powders are coated with Sn, Ni, or Cu. In the case of using metal powder in which the surfaces of the metal powders are coated with Sn, Ni, or Cu, the metal powders are preferably, for example, Ag, Cu, Ni, Sn, Bi, or an alloy thereof.

The metal included in the conductive resin layer mainly contributes to electrical conduction in the conductive resin layer. Specifically, contact between conductive fillers provides an electrical conduction path within the conductive resin layer.

The metal included in the conductive resin layer can be a spherical powder, a flat powder, or the like and preferably, a mixture of a spherical metal powder and a flat metal powder.

The resin of the conductive resin layer can be various known thermosetting resins such as, for example, epoxy resin, phenol resin, urethane resin, silicone resin, or polyimide resin. Among these resins, epoxy resin, which is excellent in heat resistance, moisture resistance, and adhesion, is one of the preferable resins.

Preferably, the conductive resin layer includes a curing agent together with thermosetting resin. For the curing agent, in the case of using epoxy resin as the base resin, various known compounds, such as, for example, phenol-based, amine-based, acid anhydride-based, imidazole-based, active ester-based, or amide imide-based compounds, can be used as the curing agent for epoxy resin.

Preferably, the maximum thickness of the conductive resin layer is, for example, about 5 μm or more and about 40 μm or less.

The plating layers 34 cover the respective underlying electrode layers 32.

The plating layers 34 include at least one of, for example, Cu, Ni, Sn, Ag, Pd, Ag—Pd alloy, Au, or the like.

Each plating layer 34 may include multiple layers. In this case, it is preferable that each plating layer 34 has a two-layer structure of Ni plating and Sn plating, for example. The Ni plating layer is used to protect the underlying electrode layers 32 from corrosion by solder for mounting of the multilayer ceramic capacitor 10. The Sn plating layer is used to improve the wettability of solder during mounting of the multilayer ceramic capacitor 10 to facilitate the mounting. The thickness of each layer of each plating layer 34 is preferably, for example, about 1 μm or more and about 6 μm or less.

The dimension of the multilayer ceramic capacitor 10, which includes the multilayer body 12 and the first and second outer electrodes 30a and 30b, in the first direction y is referred to as an L dimension. The dimension of the multilayer ceramic capacitor 10, which includes the multilayer body 12 and the first and second outer electrodes 30a and 30b, in the stacking direction x is referred to as a T dimension. The dimension of the multilayer ceramic capacitor 10, which includes the multilayer body 12 and the first and second outer electrodes 30a and 30b, in the second direction z is referred to as a W dimension.

The dimensions of the multilayer ceramic capacitor 10 are, for example, as follows: the L dimension in the first direction y is about 0.30 mm or more and about 0.80 mm or less, the W dimension in the second direction z is about 0.60 mm or more and about 1.60 mm or less, and the T dimension in the stacking direction x is about 0.10 mm or more and about 0.60 mm or less. The dimensions of the multilayer ceramic capacitor 10 can be measured with a microscope, for example.

The multilayer ceramic capacitor 10 illustrated in FIG. 1 has a dimensional relationship of w>1>t where 1 is the dimension of the multilayer body 12 in the first direction y, w is the dimension of the multilayer body 12 in the second direction z, and t is the dimension of the multilayer body 12 in the stacking direction x. The first outer electrode 30a includes the first maximum thickness point 30aP, which is the region with the greatest thickness in the stacking direction x in the first folded portion 30a₁ located on the first surface 12a side. The second outer electrode 30b includes the second maximum thickness point 30bP, which is the region with the greatest thickness in the stacking direction x in the fifth folded portion 30b₁ located on the first surface 12a side. The first maximum thickness point 30aP of the first folded portion 30a₁ and the second maximum thickness point 30bP of the fifth folded portion 30b₁ are located diagonally opposite to each other with respect to the center point CP of the first surface 12a in the first and second directions y and z. As a result, during conveyance of the multilayer ceramic capacitor 10 by equipment in the manufacturing process (the measurement process, the visual inspection process, and the packaging process) of the multilayer ceramic capacitor 10, the contact area of the multilayer ceramic capacitor 10 with the conveying section is reduced, thus reducing preventing adhesion of the multilayer ceramic capacitor 10 due to static electricity or the like and reducing or preventing conveyance failures of the multilayer ceramic capacitor 10 to improve productivity (the equipment utilization rate).

In the multilayer ceramic capacitor 10 illustrated in FIG. 1, the ratio of the thickness at the first maximum thickness point 30aP of the first folded portion 30a₁ to the thickness at the minimum thickness point of the first folded portion 30a₁ is, for example, about 1.4 or more and about 2.5 or less, and the ratio of the thickness at the second maximum thickness point 30bP of the fifth folded portion 30b₁ to the thickness at the minimum thickness point of the fifth folded portion 30b₁ is, for example, about 1.4 or more and about 2.5 or less. Such a large difference in each folded surface further reduces the contact area of the multilayer ceramic capacitor 10 with the equipment conveying section, thus reducing or preventing conveyance failures of the multilayer ceramic capacitor 10.

Next, an example of a manufacturing method of the multilayer ceramic capacitor 10 according to the present example embodiment will be described.

First, dielectric sheets for dielectric layers and a conductive paste for inner electrode layers are prepared. The dielectric sheets and the conductive paste for inner electrode layers include a binder and a solvent. The binder and solvent may be publicly known materials.

On each dielectric sheet, a predetermined pattern is printed with the conductive paste for inner electrode layers by, for example, screen printing, gravure printing, or another method. As a result, dielectric sheets with the pattern of the first inner electrode layers formed thereon and dielectric sheets with the pattern of the second inner electrode layers formed thereon are prepared.

More specifically, each inner electrode layer can be printed by, for example, preparing a gravure printing plate for printing the first and second inner electrode layers.

Next, a predetermined number of dielectric sheets with the pattern of inner electrode layers not formed thereon are stacked on top of each other, thus forming a portion to be the second outer layer section 20b on the second surface 12b side. Then, on the portion to be the second outer layer section 20b, the sheets with the first inner electrode layers formed thereon and the sheets with the second inner electrode layers formed thereon are stacked alternately to form a section to be the capacitance generating section 18. Next, on the portion to be the capacitance generating section 18, a predetermined number of dielectric sheets with the pattern of inner electrode layers not formed thereon are stacked to form a portion to be the first outer layer section 20a on the first surface 12a side. As a result, a multilayer sheet is prepared.

Subsequently, the multilayer sheet is pressed in the stacking direction by, for example, isostatic pressing or other similar processes, thus forming a multilayer block.

Next, the multilayer block is cut into a predetermined size to cut out multilayer chips. In this process, the corner and edge portions of each multilayer chip may be rounded by, for example, barrel polishing or other similar processes.

By firing each multilayer chip thus cut out, the multilayer body 12 is produced. The firing temperature, which depends on the materials of the dielectric layers 14 and the inner electrode layers 16, is preferably, for example, about 900° C. or higher and about 1400° C. or lower.

Subsequently, the first underlying electrode layer 32a of the first outer electrode 30a is formed on the third surface 12c of the multilayer body 12 obtained by firing, and the second underlying electrode layer 32b of the second outer electrode 30b is formed on the fourth surface 12d of the multilayer body 12. In the present example embodiment, using a DIP process, the first and second underlying electrode layers 32a and 32b are formed so as to extend on, not only the third and fourth surfaces 12c and 12d, but also a portion of the first surface 12a, a portion of the second surface 12b, a portion of the fifth surface 12e, and a portion of the sixth surface 12f.

In the case of forming fired layers as the underlying electrode layers 32, the fired layers as the underlying electrode layers 32 are formed by applying the conductive paste including the glass component and the metal component, followed by firing. The firing temperature in this process is preferably, for example, about 700° C. or higher and about 900° C. or lower. In the present example embodiment, the underlying electrode layers 32 are formed of fired layers.

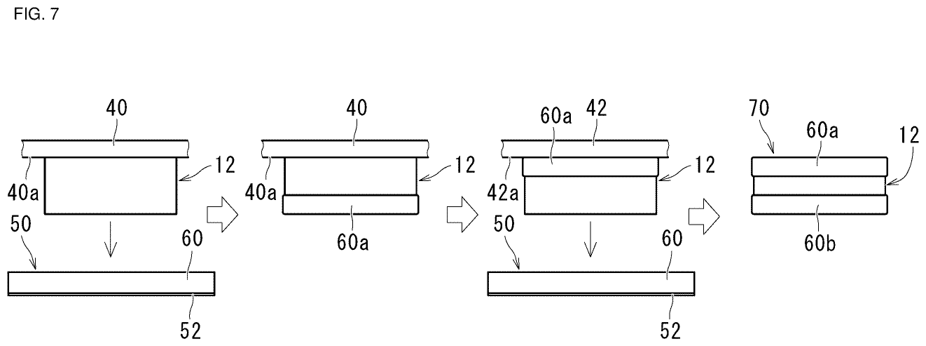

Hereinafter, an example of a method of forming the underlying electrode layers 32 will be described with reference to FIG. 7.

First, the fired multilayer body 12 is positioned with the third surface 12c facing up, and the fourth surface 12d side is fixed to an adhesive surface 40a of a first holder jig 40, which includes an adhesive layer.

The third surface 12c of the multilayer body 12 is vertically immersed in a paste bath 50, in which a conductive paste 60 is formed to a certain thickness on a metallic surface plate 52 with a blade or the like, thus forming an unsintered first underlying electrode layer 60a.

Next, the third surface 12c with the conductive paste 60 applied thereto is pressed against an adhesive surface 42a of a second holder jig 42, which includes an adhesive layer having a higher adhesive strength than that of the first holder jig 40, to transfer the fired multilayer body 12 to the second holder jig 42. The multilayer body 12 is thus fixed to the second holder jig 42 with the fourth surface 12d facing up.

The conductive paste 60 is applied to the fourth surface 12d in the same manner as the method of applying the conductive paste 60 to the third surface 12c. An unsintered second underlying electrode layer 60b is thus formed.

Subsequently, an example of a method of forming the maximum thickness portions diagonally opposite to each other in the first folded portion 30a₁ of the first outer electrode 30a and the fifth folded portion 30b₁ of the second outer electrode 30b will be described.

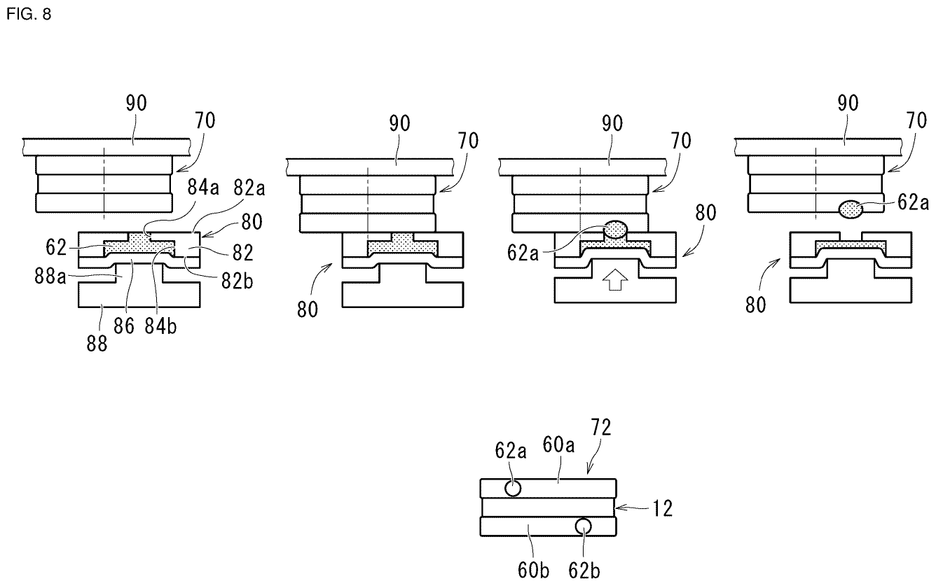

As illustrated in FIG. 8, a maximum thickness portion application apparatus 80 includes a slit plate 82, a closing member 86, and a pressing member 88. A multilayer body 70 with the unsintered underlying electrode layers formed thereon is held by a holding plate 90.

The slit plate 82 includes one major surface 82a and the other major surface 82b, which face each other with a predetermined interval therebetween. The multilayer body 70 with the unsintered underlying electrode layers formed thereon is disposed on the one major surface 82a side of the slit plate 82. On the one major surface 82a side of the slit plate 82, a plurality of slits 84a having a width corresponding to the width of conductive paste 62 to be applied to the multilayer body 12, are provided. On the other major surface 82b side of the slit plate 82, a cavity 84b, which is wider than the slits 84a, is provided. The cavity 84b is filled with the conductive paste 62 and defines a space communicating with spaces in the slits 84a. The thus-configured slit plate 82 includes a rigid body made of, for example, iron-based metal, such as stainless steel, or ceramic.

The closing member 86 is disposed so as to close the opening of the cavity 84b on the other major surface 82b side of the slit plate 82. The closing member 86 includes an elastic substance, for example, such as silicone rubber, and has a thickness of, for example, about 5 mm or less. Preferably, the closing member 86 is joined and integrated with the slit plate 82 so as to be in close contact therewith.

The pressing member 88 includes a protrusion 88a at the position facing the cavity 84b of the slit plate 82. The protrusion 88a, which is provided in the pressing member 88, has a width not greater than that of the cavity 84b.

Next, as illustrated in FIG. 8, an example of a method of forming fired layers by using the maximum thickness portion application apparatus 80 will be described.

First, the maximum thickness portion application apparatus 80 is prepared, and the slit 84a and the cavity 84b of the slit plate 82 are filled with the conductive paste 62.

Then, the cavity 84b, which is provided with the slit 84a having a certain width on the upper surface, is filled with the conductive paste 62. In order to align the multilayer body 70 with an unsintered underlying electrode layers formed thereon in a certain direction, the multilayer body 70 is held by the holding plate 90.

The third surface 12c with the unsintered underlying electrode layer formed thereon is lowered to a height at which it comes into contact with the surface of the one major surface 82a of the slit plate 82 while the position of the slit 84a is aligned with a position offset toward the fifth surface 12e from the center line in the second direction z in the multilayer body 70 held by the holding plate 90.

Subsequently, the pressing member 88 is pushed upward by air pressure or the like to extrude the conductive paste 62 filling the cavity 84b of the slit plate 82 from the slit 84a to the surface. The conductive paste 62 extruded from the slit 84a is applied to predetermined positions on the third surface 12c side and on the first surface 12a side of the unsintered first underlying electrode layer 60a formed on the third surface 12c side, thus forming a first maximum thickness portion 62a. In a similar manner, the conductive paste 62 extruded from the slit 84a is applied to predetermined positions on the fourth surface 12d side and on the first surface 12a side of the unsintered second underlying electrode layer 60b formed on the fourth surface 12d side, thus forming a second maximum thickness portion 62b.

The third surface 12c is then transferred onto the surface of the surface plate, thus removing the excess portion of the conductive paste 62 adhering to the third surface 12c. The fourth surface 12d is transferred onto the surface of the surface plate, thus removing the excess portion of the conductive paste 62 adhering to the fourth surface 12d.

Thus, a multilayer body 72 with the unsintered underlying electrode layers and the maximum thickness portions formed thereon is obtained.

Next, plating layers are formed by performing plating on the surfaces of the underlying electrode layers as needed. In the present example embodiment, two plating layers are formed on the surface of each underlying electrode layer. Specifically, for example, a Ni plating layer and a Sn plating layer are formed on each underlying electrode layer. The plating process is preferably electrolytic plating, for example. The Ni and Sn plating layers are sequentially formed by, for example, barrel plating.

As described above, the multilayer ceramic capacitor 10 according to the present example embodiment is manufactured.

Next, in order to confirm the advantageous effects of the above-described multilayer ceramic capacitor, experiments to check the occurrence rate of equipment failures and the number of tombstone defects during substrate mounting were conducted by producing experimental specimens according to the above-described manufacturing method.

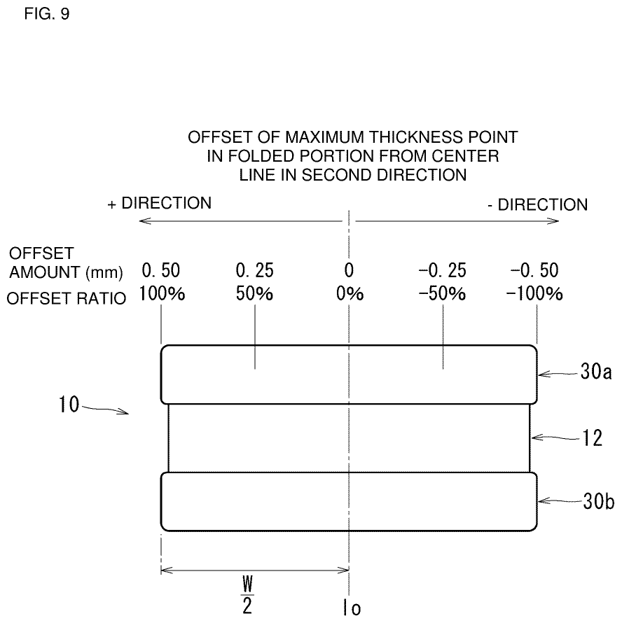

As illustrated in FIG. 9, the experimental specimens include those in which the offset amount (the offset ratio) the folded portions of the first and fifth folded portions from a center line l₀ in the second direction z was varied and those in which the ratio of the thickness at the maximum thickness point to the thickness at the minimum thickness point in the first and fifth folded portions was varied.

Multilayer ceramic capacitors as specimens with specimen Nos. 1 to 13 were produced using the manufacturing method according to the above-described example embodiment:
Structure of multilayer ceramic capacitor: multilayer ceramic capacitor illustrated in FIG. 1
Dimension of multilayer ceramic capacitor in first direction: about 0.50 mm.
Dimension of multilayer ceramic capacitor in second direction: about 1.00 mm
Dimension of multilayer ceramic capacitor in stacking direction: about 0.20 mm
Thickness of dielectric layer: about 1.00 μm
Thickness of inner electrode layer: about 0.70 μm
Number of first inner electrode layers: 43
Number of second inner electrode layers: 42
Thickness of first outer layer section: about 30 μm.
Thickness of second outer layer section: about 30 μm
Dimension of L gap: about 100 μm
Dimension of W gap: about 100 μm
Plating layer
Two-layer configuration of Ni and Sn plating layers
Thickness of Ni plating layer: about 3 μm
Thickness of Sn plating layer: about 5 μm

As a Comparative Example, specimens were prepared in which the maximum thickness points of the first and fifth folded portions were located at the center or substantially the center in the second direction z in the respective folded portions.

As Examples, specimens were prepared in which the maximum thickness points of the first and fifth folded portions were located diagonally opposite to each other with respect to the center point of the first surface in the first and second directions y and z.

Furthermore, specimens were prepared in which the ratios of the maximum thickness point to the minimum thickness point in the first and fifth folded portions were varied, and specimens were prepared in which the offset amounts from the center point in the second direction z in the first and fifth folded portions were varied.

Using a laser displacement meter (VK-X1000 made by KEYENCE CORPORATION), the positions of the maximum thickness points were identified in the first folded portion of the first outer electrode and the fifth folded portion of the second outer electrode.

For the thickness at the maximum thickness point of the first outer electrode, the height position of the maximum thickness point and the height position of the surface of the multilayer body were read from the laser displacement graph on an LT plane including the maximum thickness point. The difference between the read height positions of the maximum thickness point of the first outer electrode and the surface of the multilayer body was defined as the thickness value at the maximum thickness point of the first outer electrode.

For the thickness at the maximum thickness point of the second outer electrode, the height position of the maximum thickness point and the height position of the surface of the multilayer body were read from the laser displacement graph on an LT plane including the maximum thickness point. The difference between the read height positions of the maximum thickness point of the second outer electrode and the surface of the multilayer body was defined as the thickness value at the maximum thickness point of the second outer electrode.

Using a laser displacement meter (VK-X1000 made by KEYENCE CORPORATION), the position of the minimum thickness point in the first outer electrode was identified in a range excluding regions within about 10% of the dimension of the first folded portion in the second direction z from both ends of the first folded portion in the second direction z. In a similar manner, the position of the minimum thickness point in the second outer electrode was identified in a range excluding regions within about 10% of the dimension of the fifth folded portion in the second direction z from both ends of the fifth folded portion in the second direction z.

The thickness at the minimum thickness point of the first outer electrode was defined as follows. The height position of the minimum thickness point of the first outer electrode whose position was identified in a range excluding the regions within about 10% of the dimension of the first folded portion in the second direction z from both ends of the first folded portion in the second direction z and the height position of the surface of the multilayer body were read from the laser displacement graph at a position about half the length of the first folded portion on a WT plane. The difference between the read height positions of the minimum thickness point of the first outer electrode and the surface of the multilayer body was defined as the thickness value at the minimum thickness point of the first outer electrode.

The thickness at the minimum thickness point of the second outer electrode was defined as follows. The height position of the minimum thickness point of the second outer electrode whose position was identified in a range excluding the regions within about 10% of the fifth folded portion in the second direction z from both ends of the fifth folded portion in the second direction z and the height position of the surface of the multilayer body were read from the laser displacement graph at a position about half the length of the fifth folded portion on a WT plane. The difference between the read height positions of the minimum thickness point of the second outer electrode and the surface of the multilayer body was defined as the thickness value at the minimum thickness point of the second outer electrode.

The occurrence rate of equipment failures was checked, in which chip conveyance was stalled during conveyance by a linear feeder in a taping machine as the equipment because of specimens adhering to the conveyance surface due to static electricity or the like, resulting in failure of the specimens to be inserted into the measurement terminal position. The number of specimens used for the check was two million.

Soldering was performed for about a 1.6 mm-thick glass-epoxy substrate using Sn-3.0Ag-0.5Cu solder paste in a reflow furnace.

The peak temperature of the reflow furnace was set to about 250° C. (about 240° C. or higher: about 10 seconds, about 220° C. or higher: about 60 seconds), and the atmosphere within the reflow furnace was set to air.

After soldering, the appearance was checked, and when one of the outer electrodes was lifted off from the solder on the substrate electrode, it was determined to be a tombstone defect. The number of chips used in the check was 100.

In Table 1, specimen Nos. 1 to 8 show the occurrence rate of equipment failures and the number of tombstone defects during substrate mounting when the ratio of the thickness at the maximum thickness point to the thickness at the minimum thickness point in the first and fifth folded portions was varied.

In Table 2, specimen Nos. 9 to 13 show the occurrence rate of equipment failures and the number of tombstone defects during substrate mounting when the positions of the folded portions of the first and fifth folded portions with respect to the center in the second direction z were varied.

TABLE 1

| | | Specimen No. | | Specimen No. | | Specimen No. | | Specimen No. | |
|---|---|---|---|---|---|---|---|---|---|
| | | 1 | | 2 | | 3 | | 4 | |
| | | First | Fifth | First | Fifth | First | Fifth | First | Fifth |
| | | folded | folded | folded | folded | folded | folded | folded | folded |
| | | portion | portion | portion | portion | portion | portion | portion | portion |
| Offset of | Offset | 0.23 | −0.28 | 0.32 | −0.26 | 0.24 | −0.30 | 0.32 | −0.27 |
| maximum | amount | | | | | | | | |
| thickness | [mm] | | | | | | | | |
| point in | Offset | 46.0% | −56.0% | 64.0% | −52.0% | 48.0% | 60.0% | 64.0% | −54.0% |
| folded | ratio [%] | | | | | | | | |
| portion | | | | | | | | | |
| from | | | | | | | | | |
| center line | | | | | | | | | |
| in second | | | | | | | | | |
| direction | | | | | | | | | |
| Thickness | Maximum | 18.3 | 18.5 | 18.3 | 19.1 | 19.3 | 19.6 | 27.1 | 28.5 |
| of folded | thickness | | | | | | | | |
| portion | [μm] | | | | | | | | |
| | Minimum | 14.5 | 14.8 | 14.1 | 14.4 | 13.7 | 14.0 | 14.6 | 14.8 |
| | thickness | | | | | | | | |
| | [μm] | | | | | | | | |
| Ratio of maximum to | | 1.26 | 1.25 | 1.30 | 1.33 | 1.41 | 1.40 | 1.86 | 1.93 |
| minimum thickness | | | | | | | | | |
| of folded portion | | | | | | | | | |
| Equipment | [ppm] | 356 | | 138 | | 0 | | 0 | |
| failure | | | | | | | | | |
| rate | | | | | | | | | |
| Tombstone defect | | 0/100 | | 0/100 | | 0/100 | | 0/100 | |
| rate during substrate | | | | | | | | | |
| mounting | | | | | | | | | |
| | | Specimen No. | | Specimen No. | | Specimen No. | | Specimen No. | |
| | | 5 | | 6 | | 7 | | 8 | |
| | | First | Fifth | First | Fifth | First | Fifth | First | Fifth |
| | | folded | folded | folded | folded | folded | folded | folded | folded |
| | | portion | portion | portion | portion | portion | portion | portion | portion |
| Offset of | Offset | 0.28 | −0.33 | 0.23 | −0.28 | 0.31 | −0.24 | 0.31 | −0.25 |
| maximum | amount | | | | | | | | |
| thickness | [mm] | | | | | | | | |
| point in | Offset | 56.0% | −66.0% | 46.0% | 56.0% | 62.0% | −48.0% | 62.0% | 50.0% |
| folded | ratio [%] | | | | | | | | |
| portion | | | | | | | | | |
| from | | | | | | | | | |
| center line | | | | | | | | | |
| in second | | | | | | | | | |
| direction | | | | | | | | | |
| Thickness | Maximum | 34.7 | 33.5 | 37.5 | 37.6 | 43.5 | 42.4 | 51.3 | 50.2 |
| of folded | thickness | | | | | | | | |
| portion | [μm] | | | | | | | | |
| | Minimum | 15.2 | 14.6 | 15.0 | 14.9 | 15.3 | 14.8 | 15.5 | 15.1 |
| | thickness | | | | | | | | |
| | [μm] | | | | | | | | |

| | | | | | | | | |
|---|---|---|---|---|---|---|---|---|
| Ratio of maximum to | 2.28 | 2.29 | 2.50 | 2.52 | 2.84 | 2.86 | 3.31 | 3.32 |
| minimum thickness | | | | | | | | |
| of folded portion | | | | | | | | |

| | | | | | |
|---|---|---|---|---|---|
| Equipment | [ppm] | 0 | 0 | 0 | 0 |
| failure | | | | | |
| rate | | | | | |

| | | | | |
|---|---|---|---|---|
| Tombstone defect | 0/100 | 0/100 | 7/100 | 18/100 |
| rate during substrate | | | | |
| mounting | | | | |

TABLE 2

| | | Specimen | | Specimen | | Specimen | | Specimen | | Specimen | |
|---|---|---|---|---|---|---|---|---|---|---|---|
| | | No. 9 | | No. 10 | | No. 11 | | No. 12 | | No. 13 | |
| | | First | Fifth | First | Fifth | First | Fifth | First | Fifth | First | Fifth |
| | | folded | folded | folded | folded | folded | folded | folded | folded | folded | folded |
| | | portion | portion | portion | portion | portion | portion | portion | portion | portion | portion |
| Offset of | Offset | 0.25 | 0.27 | 0.25 | −0.04 | 0.03 | −0.02 | 0.2 | 0.44 | 0.43 | −0.46 |
| maximum | amount | | | | | | | | | | |
| thickness | [mm] | | | | | | | | | | |
| point | Offset | 50.0% | 54.0% | 50.0% | −8.0% | 6.0% | −4.0% | 46.0% | −88.0% | 86.0% | −92.0% |
| in folded | ratio [%] | | | | | | | | | | |
| portion | | | | | | | | | | | |
| from | | | | | | | | | | | |
| center | | | | | | | | | | | |
| line in | | | | | | | | | | | |
| second | | | | | | | | | | | |
| direction | | | | | | | | | | | |
| Thickness | Maximum | 29.1 | 28.5 | 29.3 | 30.1 | 28.5 | 29.6 | 29.1 | 28.5 | 30.5 | 31.2 |
| of folded | thickness | | | | | | | | | | |
| portion | [um] | | | | | | | | | | |
| | Minimum | 14.5 | 14.8 | 15.1 | 14.6 | 14.5 | 14.8 | 14.6 | 14.0 | 15.2 | 15.8 |
| | thickness | | | | | | | | | | |
| | [um] | | | | | | | | | | |

| | | | | | | | | | | |
|---|---|---|---|---|---|---|---|---|---|---|
| Ratio of maximum | 2.01 | 1.93 | 1.94 | 2.06 | 1.97 | 2.00 | 1.99 | 2.04 | 2.01 | 1.97 |
| to minimum | | | | | | | | | | |
| thickness of | | | | | | | | | | |
| folded portion | | | | | | | | | | |

| | | | | | | |
|---|---|---|---|---|---|---|
| Equipment | [ppm] | 57 | 18 | 82 | 112 | 154 |
| failure rate | | | | | | |

| | | | | | |
|---|---|---|---|---|---|
| Tombstone defect | 0/100 | 0/100 | 0/100 | 0/100 | 0/100 |
| rate during | | | | | |
| substrate mounting | | | | | |

It was discovered from specimen Nos. 1 and 2 that when the ratio was below about 1.4, the increased contact area of the chip with the conveyance surface increased the occurrence rate of equipment failures.

It was discovered from specimen Nos. 7 and 8 that when the ratio exceeded about 2.5, during substrate mounting, the inclination of the chip with respect to the substrate surface increased, and the distance between the substrate surface and the chip increased, thus causing tombstone defects during substrate mounting.

In specimen No. 9, the positions of the maximum thickness points of the first and fifth folded portions with respect to the center in the second direction z were offset in the same direction in the second direction z. The contact area of the chip during conveyance by equipment was accordingly increased, thus causing equipment failures.

In specimen Nos. 10 and 11, the offset amount of the maximum thickness point of the fifth folded portion or the maximum thickness points of the first and fifth folded portions from the center in the second direction z were small. The contact area of the chip during conveyance by equipment was accordingly increased, thus causing equipment failures.

In specimen Nos. 12 and 13, the offset amount of the maximum thickness point in the fifth folded portion or the maximum thickness points in the first and fifth folded portions from the center in the second direction z were large, and the position of any maximum thickness point overlapped a chip corner-shaped portion. The contact area of the chip during conveyance by equipment was accordingly increased, thus causing equipment failures.

According to the above evaluation results, especially in specimen Nos. 3 to 6, it was confirmed that in the manufacturing process (the measurement process, the visual inspection process, and the packaging process) of the multilayer ceramic capacitor, the reduction in the contact area of the chip with the conveying section during chip conveyance by equipment reduces or prevents adhesion of the chip due to static electricity or the like, thus reducing or preventing conveyance failures to improve productivity (the equipment utilization rate).

Furthermore, it was confirmed that the contact area of the chip with the equipment conveying section is reduced by locating the maximum thickness point of the first folded portion and the maximum thickness point of the fifth folded portion diagonally opposite to each other with respect to the center point of the chip in the first direction y and second direction z.

Still furthermore, it was confirmed that the large difference in thickness between the maximum and minimum points in the first folded portion and the fifth folded portion reduces the contact area of the chip with the equipment conveying section, thus further reducing or preventing the chip conveyance failures.

As described above, example embodiments of the present invention are disclosed in the above description, but the present invention is not limited thereto.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of stacked dielectric layers, a plurality of inner electrode layers stacked on respective dielectric layers of the plurality of dielectric layers, a first surface and a second surface facing each other in a stacking direction, a third surface and a fourth surface facing each other in a first direction perpendicular or substantially perpendicular to the stacking direction, and a fifth surface and a sixth surface facing each other in a second direction perpendicular or substantially perpendicular to the stacking direction and the first direction;
a first inner electrode layer extending to the third surface;
a second inner electrode layer extending to the fourth surface;
a first outer electrode on the third surface and connected to the first inner electrode layer; and
a second outer electrode on the fourth surface and connected to the second inner electrode layer; wherein
a dimension of the multilayer body in the first direction is shorter than a dimension of the multilayer body in the second direction;
a dimension of the multilayer body in the stacking direction is shorter than the dimension of the multilayer body in the first direction;
the first outer electrode includes:
a first cover portion on the third surface;
a first folded portion on a portion of the first surface;
a second folded portion on a portion of the second surface;
a third folded portion on a portion of the fifth surface; and
a fourth folded portion on a portion of the sixth surface;
the second outer electrode includes:
a second cover portion on the fourth surface;
a fifth folded portion on a portion of the first surface;
a sixth folded portion on a portion of the second surface;
a seventh folded portion on a portion of the fifth surface; and
an eighth folded portion on a portion of the sixth surface;
the first folded portion includes a first maximum thickness point that is a region with a greatest thickness in the stacking direction;
the fifth folded portion includes a second maximum thickness point that is a region with a greatest thickness in the stacking direction; and
the first maximum thickness point of the first folded portion and the second maximum thickness point of the fifth folded portion are located diagonally opposite to each other with respect to a center point of the first surface in the first direction and the second direction.

2. The multilayer ceramic capacitor according to claim 1, wherein
the first maximum thickness point of the first folded portion is located on the fifth surface side of a center of the first folded portion in the second direction; and
the second maximum thickness point of the fifth folded portion is located on the sixth surface side of a center of the fifth folded portion in the second direction.

3. The multilayer ceramic capacitor according to claim 2, wherein
the first maximum thickness point of the first folded portion is located at a position excluding a range of about ±10% of the length of the first folded portion in the second direction from the center of the first folded portion in the second direction; and
the second maximum thickness point of the fifth folded portion is located at a position excluding a range of about ±10% of the length of the fifth folded portion in the second direction from the center of the fifth folded portion in the second direction.

4. The multilayer ceramic capacitor according to claim 3, wherein
the first maximum thickness point of the first folded portion is located in a range excluding regions within about 10% of the length of the first folded portion in the second direction from both ends of the first folded portion in the second direction; and
the second maximum thickness point of the fifth folded portion is located in a range excluding regions within about 10% of the length of the fifth folded portion in the second direction from both ends of the fifth folded portion in the second direction.

5. The multilayer ceramic capacitor according to claim 4, wherein
a minimum thickness point is included in a region of the first folded portion that is specified in a range excluding regions within about 10% of the dimension of the first folded portion in the second direction from both ends of the first folded portion in the second direction;
a minimum thickness point is included in a region of the fifth folded portion that is specified in a range excluding regions within about 10% of the dimension of the fifth folded portion in the second direction from both ends of the fifth folded portion in the second direction;
a ratio of the thickness at the maximum thickness point of the first folded portion to the thickness at the minimum thickness point of the first folded portion is about 1.4 or more and about 2.5 or less; and
a ratio of the thickness at the maximum thickness point of the fifth folded portion to the thickness at the minimum thickness point of the fifth folded portion is about 1.4 or more and about 2.5 or less.

6. The multilayer ceramic capacitor according to claim 5, wherein
a dimension in the first direction including the multilayer body and the first and second outer electrodes is about 0.20 mm or more and about 0.80 mm or less; and
a dimension in the second direction including the multilayer body and the first and second outer electrodes is about 0.40 mm or more and about 1.60 mm or less.

7. The multilayer ceramic capacitor according to claim 1, wherein
the first inner electrode layer and the second inner electrode layer include Cu as a main component; and
the plurality of dielectric layers include, as a main component, a ceramic material including at least one of Ca, Sr, Zr, or Ti.

8. The multilayer ceramic capacitor according to claim 1, wherein each of the plurality of dielectric layers includes BaTiO₃, CaTiO₃, SrTiO₃, or CaZro₃ as a main component.

9. The multilayer ceramic capacitor according to claim 8, wherein each of the plurality of dielectric layers includes a Mn compound, an Fe compound, a Cr compound, a Co compound, or a Ni compound as a secondary component.

10. The multilayer ceramic capacitor according to claim 1, wherein a thickness of each of the plurality of dielectric layers is about 0.30 μm or more and about 5.00 μm or less.

11. The multilayer ceramic capacitor according to claim 1, wherein a thickness of each of the first and second inner electrode layers is about 0.30 μm or more and about 3.00 μm or less.

12. The multilayer ceramic capacitor according to claim 1, wherein each of the first and second inner electrode layers includes Ni, Cu, Ag, Pd, or Au, or an alloy including at least one of Ni, Cu, Ag, Pd, or Au.

13. The multilayer ceramic capacitor according to claim 1, wherein
the first outer electrode includes a first underlying electrode layer and a first plating layer on the first underlying electrode layer; and
the second outer electrode includes a second underlying electrode layer and a second plating layer on the second underlying electrode layer.

14. The multilayer ceramic capacitor according to claim 1, wherein each of the first and second underlying electrode layers includes a fired layer including a glass component and a metal component.

15. The multilayer ceramic capacitor according to claim 14, wherein the glass component includes at least one of B, Si, Ba, Mg, Al, or Li.

16. The multilayer ceramic capacitor according to claim 14, wherein the metal component includes at least one of Cu, Ni, Ag, Pd, Ag—Pd alloy, or Au.

17. The multilayer ceramic capacitor according to claim 14, wherein a maximum thickness of each of the first and second underlying electrode layers in the first direction is about 10 μm or more and about 40 μm or less.

18. The multilayer ceramic capacitor according to claim 14, wherein each of the first and second underlying electrode layers includes a conductive resin layer on the fired layer.

19. The multilayer ceramic capacitor according to claim 18, wherein the conductive resin layer includes a thermosetting resin and metal.

20. The multilayer ceramic capacitor according to claim 19, wherein the thermosetting resin includes epoxy resin.
